(19) United States
(12) Patent Application Publication
(10) Pub. No.: US 2026/0361527 A1
(43) Pub. Date: Nov. 12, 2026

(54) MEMORY ENCRYPTION WITH DYNAMIC KEY DIVERSIFICATION

(71) Applicant: MICROSOFT TECHNOLOGY LICENSING, LLC, Redmond, WA (US)

(72) Inventors: Kunyan LIU, San Diego, CA (US); Yucong TAO, San Diego, CA (US)

(21) Appl. No.: 19/204,384

(22) Filed: May 9, 2025

(51) Int. Cl. H04L 9/08

(52) U.S. Cl. CPC H04L 9/0861

(57) ABSTRACT

The disclosed techniques provide a method for encrypting input data. A precomputed seed value is evaluated based on a master data key. A key derivation context value is evaluated based on at least one context value. An initial state value is evaluated by XORing the precomputed seed value with the key derivation context value. A data key is generated based on performing exactly one Keccak permutation based on the initial state value. The data key is unique to the target memory block. Performing the exactly one Keccak permutation on the initial state value enables generation of the data key with exactly one Keccak permutation invocation. Based, at least in part, on the data key, the input data is encrypted.

### BACKGROUND

In datacenters, ensuring the security of data stored in off-chip memories is paramount. Datacenters often host multiple virtual machines or processes that share resources, making secure storage a critical concern. One common method for securing off-chip memories involves encrypting the data before storing the data. This helps prevent unauthorized access and protect sensitive information from potential breaches. However, existing encryption methods face several challenges, primarily related to key management, performance overhead, and security vulnerabilities. In particular, many encryption methods require frequent re-keying, which may be very disruptive to existing workloads. In addition, existing encryption methods may be vulnerable to various cryptographic attacks.

These challenges can occur with existing encryption schemes, which often rely on static keys that remain unchanged over extended time periods. The use of static keys introduces significant security risks. As more data is encrypted using the same key, the security risk increases since the accumulation of encrypted data increases the likelihood that a security key can be derived from the encrypted data.

Frequent re-keying can address the above-described issue. However, frequent re-keying can cause significant disruptions and introduce substantial latency and complexity. In many systems, when re-keying occurs, it is necessary to stop all existing workloads and reboot the system, which can cause significant disruption. For security reasons, in a datacenter, it is standard to perform a rekey after every 2³⁶ blocks of memory accesses. However, at current throughputs, 2³⁶ blocks can be achieved very quickly, thus requiring frequent re-keying. If re-keying is performed less frequently, the risk of successful cryptographic attacks increases.

Side-channel attacks represent another critical concern in data security. In these types of attacks, adversaries exploit physical characteristics of the system, such as power consumption or electromagnetic emissions, to deduce secret keys. Static keys are particularly vulnerable to such attacks because they remain constant and can be targeted by sophisticated adversaries.

### SUMMARY

To address the challenges described above, the disclosed techniques perform memory encryption with key diversification. Individual sections of data stored in off-chip memory is encrypted using a unique key derived specifically for its memory block, while also minimizing latency and power consumption. By using a unique key for each memory block, there is no need for frequent re-keying and therefore the disruption caused by frequent re-keying is avoided. Also, using a unique key for each memory block enhances security against various cryptographic attacks.

A unique key is derived for each memory block based on a master data key using a strong cryptographic function, such as a Keccak Message Authentication Code (KMAC)-based key derivation function (KDF), that is based on the Keccak permutation. KMAC is a cryptographic algorithm used for message authentication and hashing that makes use of the Keccak permutation. The Keccak permutation is a cryptographic permutation function based on a sponge construction that is designed to be resistant against various cryptographic attacks.

Typically, deriving a new key using a cryptographic function that is based on the Keccak permutation would require 20 to 30 clock cycles. However, in some embodiments, the key derivation can instead be performed with substantially fewer clock cycles than this. This is accomplished by precomputing a seed value and performing exactly one Keccak permutation during the key derivation, rather than performing multiple iterations of the Keccak permutation to derive each new key.

More specifically, prior to encryption, the seed value is precomputed based on the master data key. A new, unique key is derived from the master data key for each address memory block to which data is written, but, in some embodiments, precomputing the seed value is performed at most once per power cycle. Each time a new key is derived, the precomputed seed value is combined with a key derivation context to generate an initial state value. The key derivation context is based on at least one context value, such as the memory address where the data will be stored or other relevant parameters. Exactly one iteration of the Keccak permutation is performed on this initial state value to derive a data key. Based on the derived data key, the plaintext data intended for storage is encrypted.

As explained above, exactly one iteration of the Keccak permutation is used to derive the data key. Using exactly one iteration of the Keccak permutation allows for efficient key generation while maintaining robust encryption. Previously, as explained above, in order to derive a new key from a master key using a cryptographic function that is based on the Keccak permutation, 20 to 30 clock cycles would typically be required. However, if a new key were derived from every memory block using 20 to 30 clock cycles to derive each new key, the latency would typically be too great to be acceptable for use in writing to off-chip memory in a datacenter environment. However, in some embodiments, the seed value is precomputed and exactly one Keccak permutation is used for a KMAC-based KDF to derive the new key for each memory block to which data is written. In this way, a new key can be derived in about 5 clock cycles. Accordingly, a new key can be derived for each memory block to which data is written while minimizing latency.

Also, this approach ensures that every write access to off-chip memory involves generating a new, unique encryption key specific to the targeted memory block. By doing so, this approach enhances security against various attacks, including side-channel attacks and brute force cryptanalysis attempts. Additionally, the use of a unique key for each memory block may obviate the need for using a tweakable block cipher in the encryption of the data.

Accordingly, rather than using static keys, a new, unique key is derived for each memory block to which data is written. Even if the same plaintext data is encrypted multiple times, to be written to different memory address blocks, the data will be encrypted with a unique key each time. The use of a unique key per memory block mitigates issues related to frequent re-keying and reduces security vulnerabilities often associated with static keys used over extended time periods.

In this way, enhanced security and improved performance can be achieved without introducing significant latency, throughput, or power consumption overheads.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 is a functional block diagram of an embodiment of a data encryption module that performs data encryption with dynamic key derivation.

FIG. 2 is a block diagram of an embodiment of a server node that includes an SoC that includes a memory controller that includes an embodiment of the data encryption module of FIG. 1.

FIG. 3A is a functional block diagram of an embodiment of the data encryption module of FIG. 1 in which the precomputed seed value is evaluated from the master data key prior to encryption.

FIG. 3B is a functional block diagram of an embodiment of the data encryption module of FIG. 3A in which the key derivation context is generated from the encryption context.

FIG. 3C is a functional block diagram of an embodiment of the data encryption module of FIG. 3B in which the initial state value is evaluated from the key derivation context and the precomputed seed value.

FIG. 3D is a functional block diagram of an embodiment of the data encryption module of FIG. 3C in which the Keccak permutation output value is evaluated by performing exactly one Keccak permutation on the initial state value.

FIG. 3E is a functional block diagram of an embodiment of the data encryption module of FIG. 3D in which the data key is provided by truncating the Keccak permutation output value.

FIG. 3F is a functional block diagram of an embodiment of the data encryption module of FIG. 3E in which the input data is encrypted with the data key.

FIG. 4 is a functional block diagram of an embodiment of the data decryption module of FIG. 2.

FIG. 5 is a block diagram of another embodiment of the data encryption module of FIG. 1.

FIG. 6 is a flow diagram showing aspects of a routine for implementing aspects of the disclosed techniques.

FIG. 7 is a computer architecture diagram illustrating a computing device architecture for a computing device capable of implementing aspects of the techniques and technologies presented herein.

### DETAILED DESCRIPTION

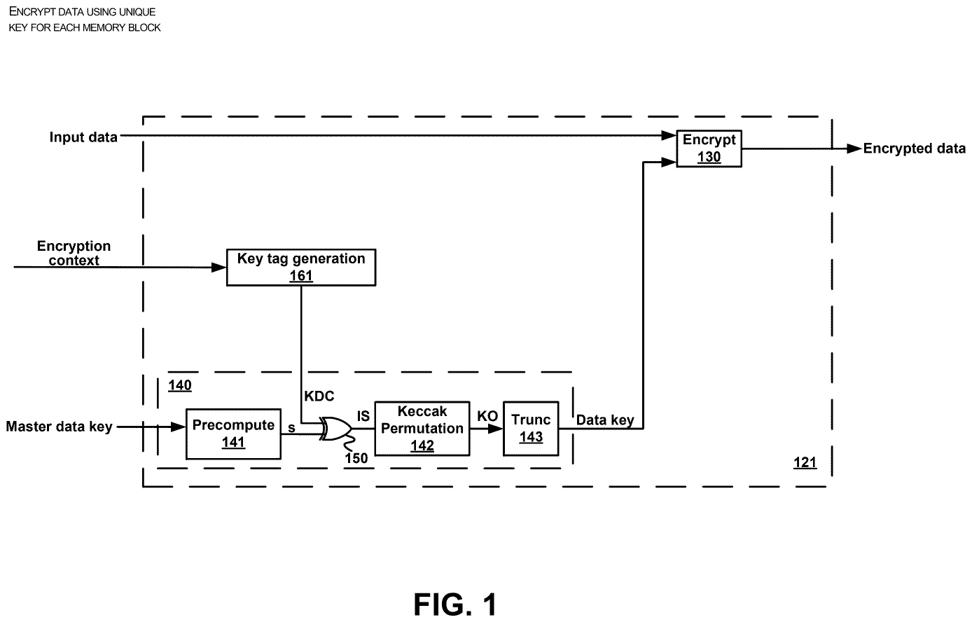

FIG. 1 is a functional block diagram of an embodiment of a data encryption module (121). The data encryption module 121 includes an encryption engine (130), a key tag generation block (161), and a key derivation block (140). The key derivation block 140 includes a precompute block (141), an XOR gate (150), a Keccak permutation block (142), and a truncation block (143).

The data encryption module 121 performs data encryption of input data, which is the data that is intended for storage in a destination memory. In some embodiments, the data encryption module 121 is part of a memory controller of an SoC. In some of these embodiments, the destination memory is an off-chip memory, and the input data is plaintext data that is intended for storage in the off-chip memory after the data is encrypted.

The data encryption module 121 uses key diversification, in which individual sections of data encrypted by the data encryption module 121 is encrypted using a unique key derived specifically for its memory block in the destination memory. Each time data is to be encrypted, if a unique key does not already exist for the destination memory block, the data encryption module 121 generates the unique key for that memory block. The data encryption module 121 then uses the unique key to encrypt the input data. The key derivation block 140 derives each unique key from a master data key using a strong cryptographic function (e.g., a KMAC-based key derivation function) that is based on the Keccak permutation.

The Keccak permutation is a cryptographic permutation function that is based on a sponge construction. Exactly one Keccak permutation is used in generating each unique key. Using only one Keccak permutation to generate each unique key is possible by precomputing a portion of the input to the Keccak permutation known as the seed value(s), as explained in greater detail below. By using only one iteration of the Keccak permutation to derive each unique key, each unique key can be derived in a relatively small number of clock cycles. In this way, a new key can be derived for each memory block while minimizing latency.

Prior to the encryption of any data, the precompute block 141 precomputes the seed value(s) from the master data key. The precomputation of the seed value(s) is performed as follows. First, any necessary padding is performed on the master data key. “Padding” refers to the adding of zeroes necessary to the master data key to ensure that the master data key has the proper size to precompute the seed value(s). If the master data key already has the proper size (in number of bits) for determining the seed value(s), no padding is performed. If the master data key is not the proper size for determining the seed value(s), a sufficient number of zeroes is concatenated to the end of the master data key until the padded master data key has the proper size for determining the seed value(s). In some embodiments, the proper size for determining the seed value(s) is 1600 bits. Accordingly, in these embodiments, if the master data key is less than 1600 bits, a sufficient number of zeroes is concatenated to the end of the master data key until the padded master data key has 1600 bits.

After any necessary padding, the precompute block 141 generates the precomputed seed value(s) from the padded master data key. The generation of the seed value(s) from the padded master key is explained in greater detail below. The precomputed seed value(s) is then used for all subsequently derived data keys until the master data key is rotated. When the master data key is rotated, the seed value(s) is precomputed again, and the new precomputed seed value(s) is then used for all subsequently derived data keys until the master data key is rotated yet again. For instance, in various embodiments, the master data key may be rotated at each new power cycle or according to other suitable timing. In some embodiments, the master data key is rotated less frequently than once per power cycle. For example, in some embodiments, as discussed in greater detail below, a session salt is used, which allows the master data key to be rotated less frequently than once per power cycle while still maintaining a high degree of security.

The data encryption module 121 performs encryption on each section of data that is going to the destination memory. The data encryption performed in the following way. First, encryption context associated with the data being encrypted is provided to the key tag generation block 161. In response to receiving the encryption context, the key tag generation block 161 generates a key derivation context value (KDC) based on the encryption context. Generation of the key derivation context value KDC is described in greater detail below.

Next, the XOR gate 150 XORs the precomputed seed value(s) with the key derivation context value KDC to provide an initial state value (IS). Next, the Keccak permutation block 142 performs exactly one Keccak permutation on the initial state value IS to provide a Keccak permutation output value (KO). The Keccak permutation output value KO is provided to truncation block 143. Truncation block 143 performs truncation on the Keccak permutation output value KO, if necessary, to generate the data key. The truncation is performed based on the length of the data key required by the encryption algorithm used by the encryption engine 130.

The data key and the input data are both provided as inputs to the encryption engine 130. In response, the encryption engine 130 provides encrypted data. More specifically, the encryption engine 130 uses a suitable encryption algorithm for encrypting the input data using the data key.

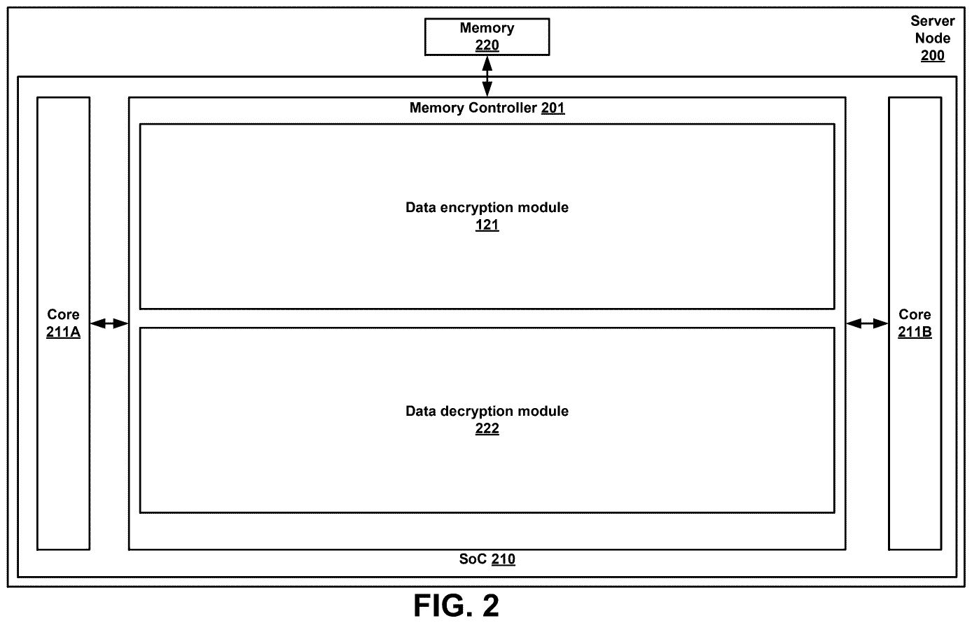

FIG. 2 is a block diagram of a server node (200). The server node 200 includes a system-on-a-chip (SoC) 210 and a memory (220). The SoC 210 includes a first core (211A), a second core (211B), and a memory controller (201). The memory controller 201 includes a data encryption module (121) and a data decryption module (222). The data encryption module 121 of FIG. 2 may be an embodiment of the data encryption module 121 of FIG. 1.

The server node 200 is a computing device designed to host multiple virtual machines or processes in a datacenter environment. The server node includes the SoC 210 and the memory 220, which is an off-chip memory. The memory 220 may be a dynamic random-access memory (DRAM), such as double data rate synchronous DRAM (DDR), low-power DDR (LPDDR), high-bandwidth memory (HBM), another suitable type of DRAM, or another suitable type of off-chip memory. The SoC 210 integrates multiple cores 211 to handle diverse computational tasks efficiently. The SoC 210 also includes the memory controller 201, which manages data storage operations using memory 220. When a write access is initiated to the memory 220, the data encryption module 121 performs data encryption on data that is to be stored in the memory 220 before the data leaves the SoC 210. Encrypting the data is done to prevent unauthorized access and to protect sensitive information from potential breaches. Memory 220 includes multiple memory blocks. The data encryption module 121 derives a unique key for each destination memory block of the memory block of the memory 220 to which data is written.

The memory controller 201 initiates the write access by encrypting the data that is to be written to the memory 220 and outputting the encrypted data along with control signals or metadata necessary for the correct placement of the encrypted data in the memory 220. After the memory controller 201 initiates the write access by outputting the encrypted data along with control signals or metadata necessary for the correct placement of the encrypted data in the memory 220, the server node 210 completes the write access to the memory 220. The control signals or metadata necessary for the correct placement of the encrypted data in the memory 220 includes the target memory address of the encrypted data. In some embodiments, the control signals or metadata also include enable signals, timing control, handshaking protocols, or context information such as virtual machine identifiers, session-specific metadata, or the like. When data is read from the memory 220, the encrypted data and the memory address in the memory 220 from which the encrypted data was accessed is provided to the memory controller 201. The encrypted data is then decrypted by the data encryption module 222 before the data is sent to the core 211 on the SoC 210 that made the read access.

Although FIG. 2 discusses embodiments of the data encryption and the data decryption using key diversification in the context of SoCs with external memories, the data encryption and data decryption using key diversification can also be used in other contexts, including storage encryption and other suitable contexts.

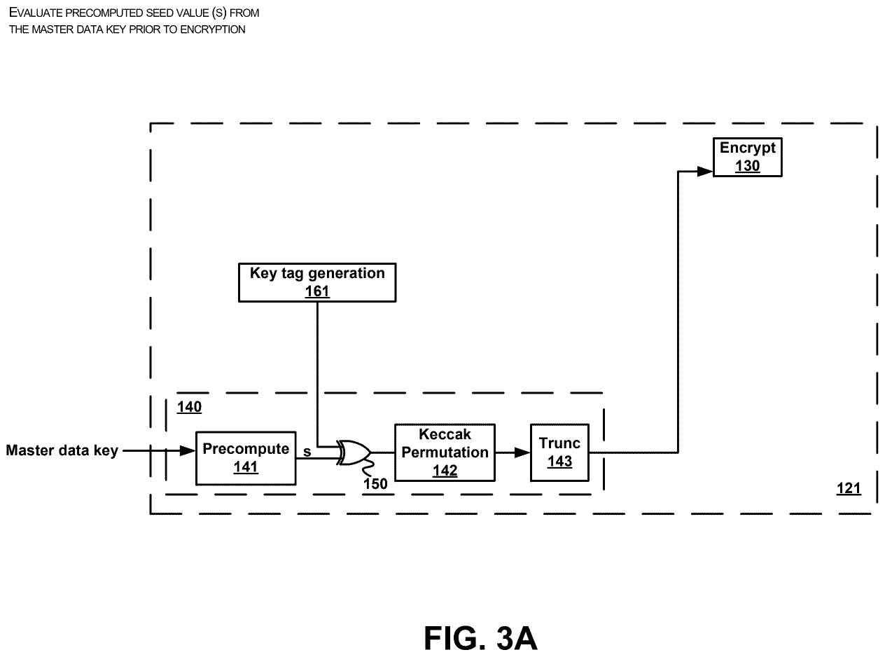

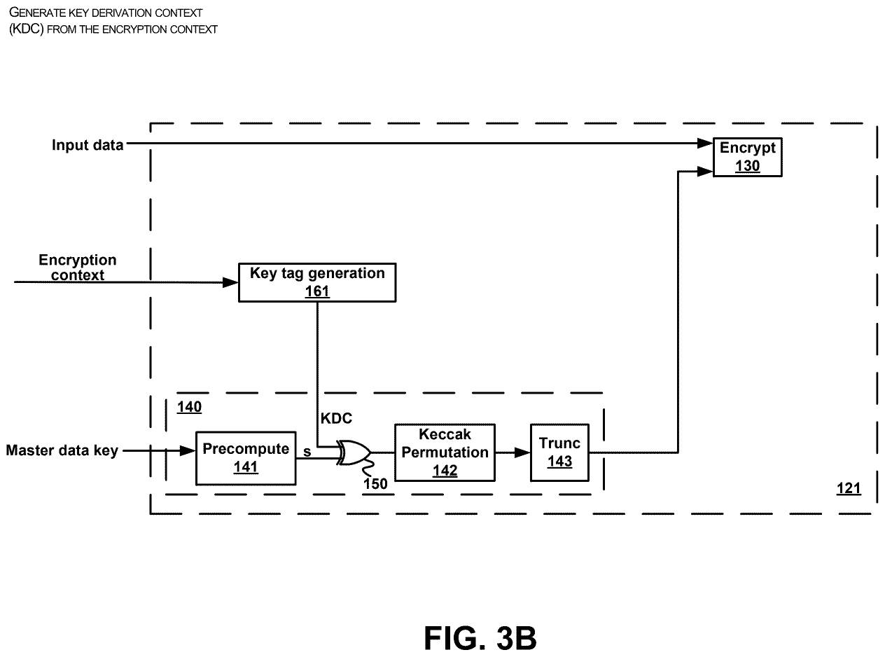

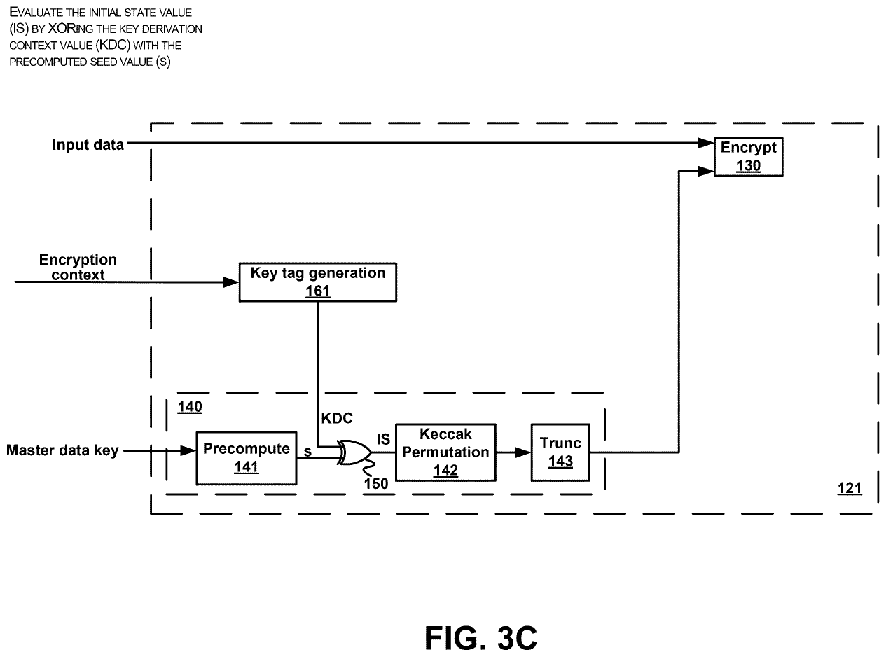

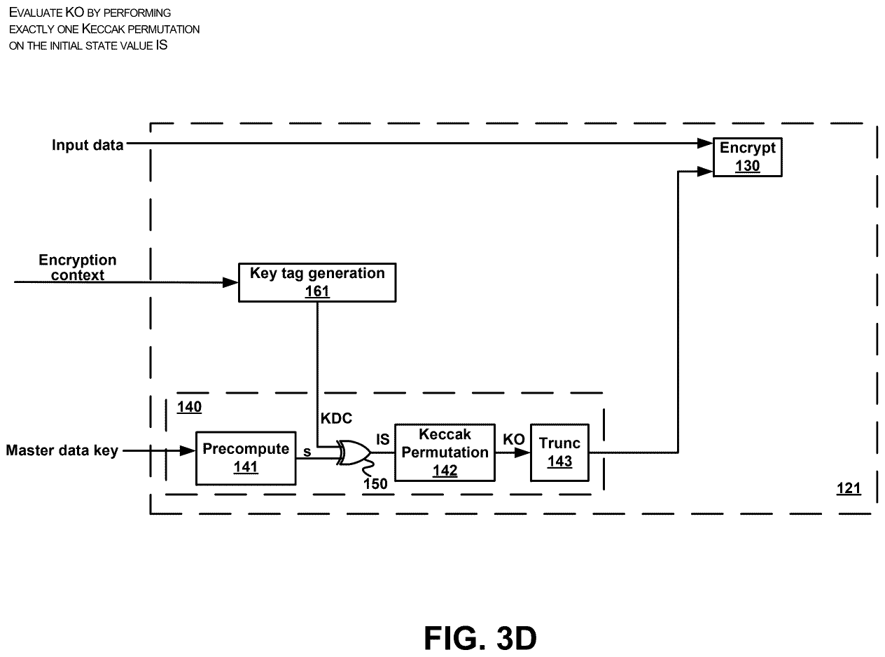

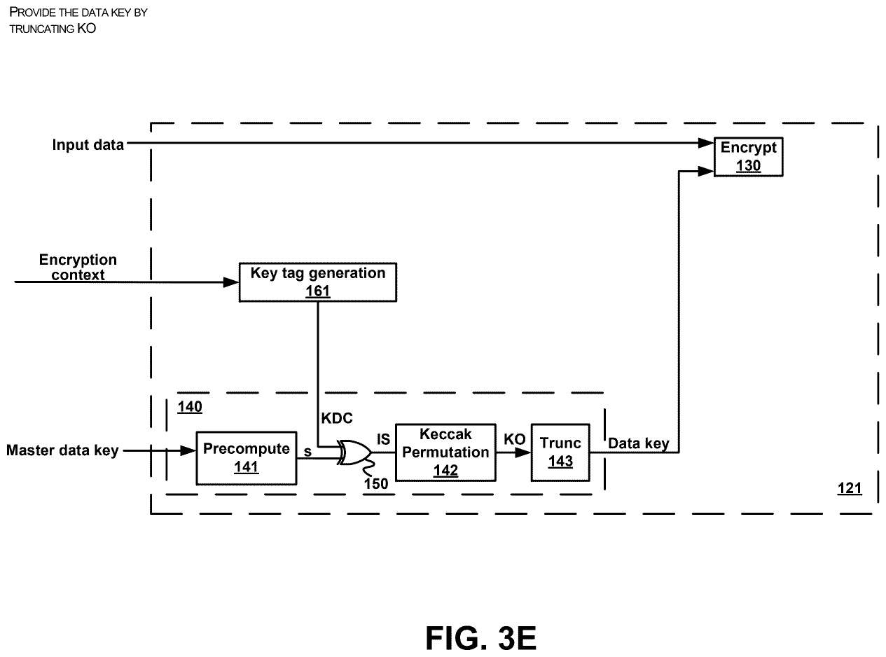

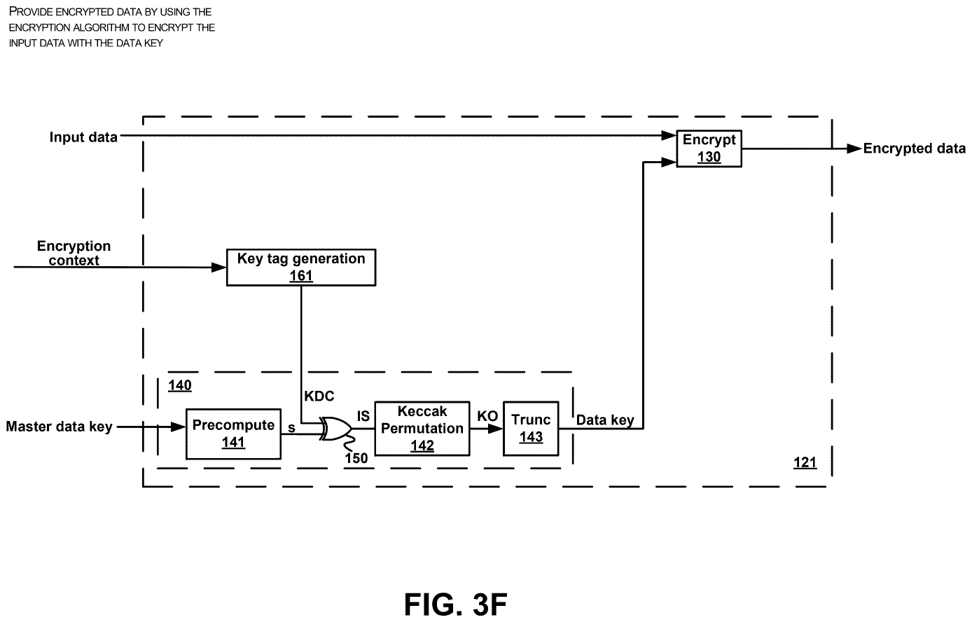

FIG. 3A-3F are functional block diagrams of an embodiment of a data encryption module (121). The data encryption module 121 of FIGS. 3A-3F may be an embodiment of the data encryption module 121 of FIG. 1 or FIG. 2.

As shown in FIG. 3A, prior to the encryption of any data by the data encryption module 121, the precompute block 141 evaluates the precomputed seed value(s) from the master data key. First, the precompute block 141 performs any necessary padding on the master data key, as explained in greater detail above. Next, the precompute block 141 generates the precomputed seed value(s) from the padded master data key.

The precompute block 141 generates the precomputed seed value(s) from the padded master data key by designating the first n bits of the padded master data key as the precomputed seed value(s) and the remaining bits as the capacity (c). This seed value(s) is sometimes referred to as a rate value (r). The number of bits n used for the precomputed seed value(s) is predetermined based on a preselected tradeoff between security requirements and performance considerations. In some embodiments, n is 1100 (i.e., the first 1100 bits of the padded master data key are used as the precomputed seed value(s) in these embodiments). After the precompute block 141 generates the precomputed seed value(s), the precompute block 141 stores the precomputed seed value(s) for later use in the key derivation. For example, in some embodiments, the precompute block 140 includes registers, and the precompute block 141 stores the precomputed seed value(s) in the registers.

Next, as shown in FIG. 3B, the key tag encryption block 161 generates the key derivation context value (KDC) from the encryption context, which includes at least one context value. For example, in various embodiments, the encryption context may include the destination memory address for the input data, a portion of the destination memory address, a virtual machine identifier (ID) of the virtual machine associated with the input data, a session number associated with the input data, or other suitable context information. In some embodiments, key derivation context value KDC is simply the most significant bit of the destination memory address. In various embodiments, various other processing may be performed upon one or more different types of encryption context, and possibly other inputs in some embodiments, to generate the key derivation context value KDC.

Next, as shown in FIG. 3C, the XOR gate 150 receives the key derivation context value KDC as one input and receives the precomputed seed value(s) as another input. The XOR gate 150 evaluates the initial state value (IS) by XORing the key derivation context value KDC with the precomputed seed value(s).

Next, as shown in FIG. 3D, the Keccak permutation block 142 receives the initial state value IS. The Keccak permutation block 142 performs exactly one Keccak permutation on the initial state value IS to provide the Keccak permutation output value KO. In various embodiments, any suitable Keccak permutation function may be used. The Keccak permutation is performed on the initial state value IS using a series of rounds. In some embodiments, 24 rounds are performed. In these embodiments, each round includes five operations that mix the state, known as the Theta operation, the Rho operation, the Pi operation, the Chi operation, and the Iota operation.

Next, as shown in FIG. 3E, the truncation block 143 receives the Keccak permutation output value KO. The truncation block 143 truncates the Keccak permutation output value KO to provide the data key. Truncation may be necessary because, in some embodiments, the encryption engine 130 requires a key having a particular number of bits. For example, the AES- 256 algorithm requires a data key having exactly 256 bits. The Keccak permutation provides an output of variable length, and thus truncation may be needed to ensure that the data key has the number of bits necessary for use by the encryption engine 130. If truncation is needed, the truncation block 143 provides the data key by truncating the Keccak permutation output value KO so that the data key has the correct number of bits for the data key for use by the encryption algorithm used by the encryption engine 130. If the Keccak permutation output value KO already happens to be the correct number of bits for the data key for use by the encryption engine 130, then the Keccak permutation output value KO is not truncated and is instead simply provided as the data key.

Next, as shown in FIG. 3F, the encryption engine 130 receives data key and the input data. In response, the encryption engine 130 provides encrypted data by using the data key to encrypt the input data. In some embodiments, the encryption engine 130 uses the AES-256 encryption algorithm. In other embodiments, the encryption engine 130 uses a suitable encryption algorithm other than the AES-256 encryption algorithm.

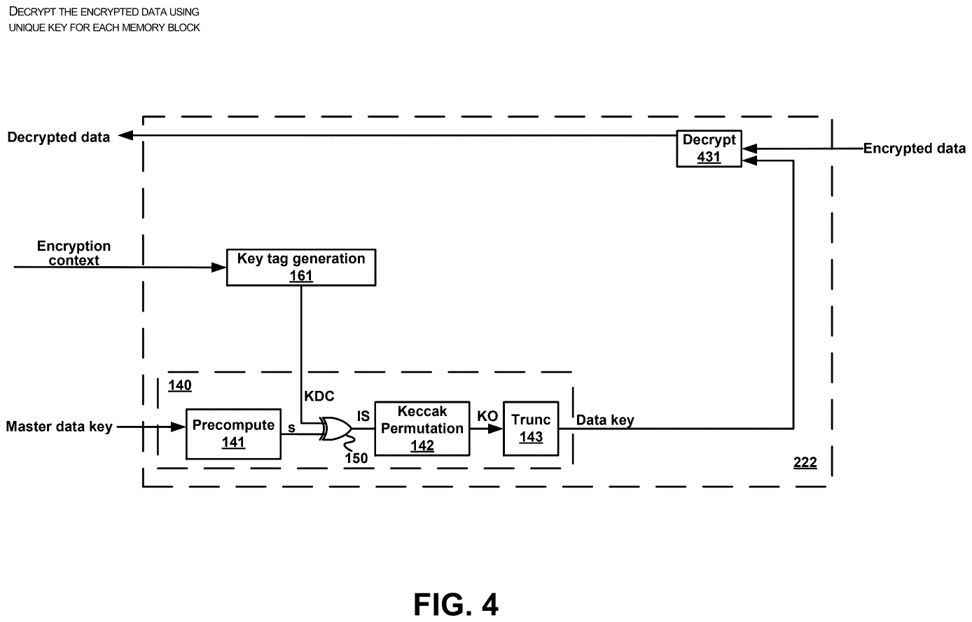

FIG. 4 is a functional block diagram of an embodiment of a data decryption module (222). The data decryption module 222 of FIG. 4 may be used as an embodiment of the data decryption module 222 of FIG. 2. The data decryption module 222 includes a decryption engine (431), a key tag generation block (161), and a key block derivation block (140).

Prior to the decryption of any data, the data decryption module 222 precomputes the seed value(s). This is the same precomputation performed in the data encryption. The same precomputation may be used for both the encryption and the decryption of data.

During decryption of data, the key derivation block 140 generates the data key in the same manner as discussed above for data encryption. There is a unique key for each memory block, but the key derivation block 140 generates the same key for the memory block from which the encrypted data came. The decryption engine 431 receives the data key and the decrypted data and generates the decrypted data by decrypting the encrypted data with the data key. The decryption engine 431 decrypts the encrypted data based on the same algorithm that was used to encrypt the data by the encryption engine 130.

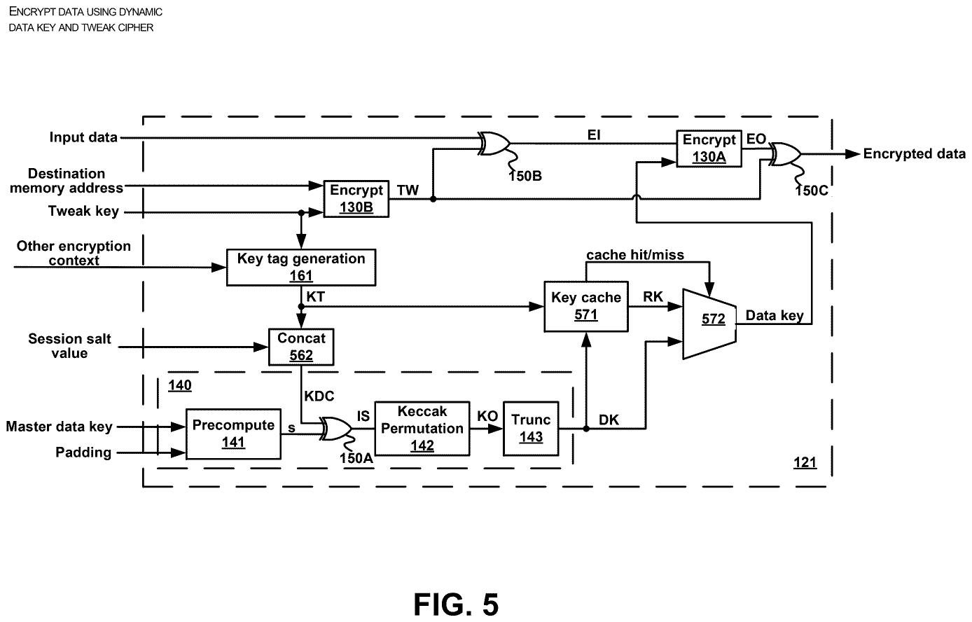

FIG. 5 is a functional block diagram of an embodiment of a data encryption module (121). The data encryption module 121 may be an embodiment of the data encryption module 121 of FIGS. 1, 2, or 3A-3F. The data encryption module 121 includes a first encryption engine (130A), a second encryption engine (130B), a first NOR gate (150B), a second NOR gate (150C), a key tag generation block (161), a concatenation block (562), a key cache (571), a multiplexer (572), and a key derivation block (140). The key derivation block 140 includes a precompute block (141), a third NOR gate (150A), a Keccak permutation block (142), and a truncation block (143).

Prior to the encryption of any data, and after each rotation of the master data key, the precompute block 141 receives the master data key and padding, and provides the precomputed seed value(s), as discussed in greater detail above. When data is to be encrypted, the data encryption module 121 receives the input data, the destination memory address, and other encryption context associated with the input data. The other encryption context may include, for example, a virtual machine ID, a session number, or other suitable encryption context. During encryption of the input data, derivation of the data key is performed in parallel with a tweak cipher. The tweak cipher modifies the encrypted data based on a tweak key and the destination memory address, as discussed in greater detail below.

Whenever a unique key is derived by the key derivation block 140, a copy of the derived key (DK) is stored in the key cache 571. If a subsequent memory access occurs to the memory block that is associated with the unique data key, the unique data key can be retrieved from the key cache 571 as a retrieved key (RK) at that time. Use of the key cache 571 provides increased efficiency and reduced power consumption.

When encryption is being performed, the key tag generation block 161 generates a key tag value (KT) from at least one context value. In some embodiments, the at least one context value includes the destination memory address and the other encryption context. The key tag value (KT) is used to look up the data key associated with the destination memory address in the key cache 571 and to retrieve the key from the key cache 571 as the retrieved key RK on a cache hit. On a cache hit, the retrieved key RK is provided to the multiplexer 572. On a cache miss, the key tag value KT is provided to the concatenation block 562. The concatenation block 562 concatenates the key tag value KT with a session salt value to evaluate the key derivation context value KDC. The session salt value is a secret random value that is generated by the memory controller 201 (of FIG. 2) once per session or once per channel. In some embodiments, the session salt value is generated in response to a predetermined event. For example, in some embodiments, the predetermined event is a power cycle. In some embodiments, the predetermined event is a new secure communication channel between the memory controller 201 (of FIG. 2) and the memory 220 (of FIG. 2). In other embodiments, the predetermined event may be any suitable event for generating a new session salt value in response to the event, such as any suitable indication of a new session or a new channel. The use of a session salt value provides improved resistance to side channel attacks. Also, the use of a session salt value may allow the master data key to be rotated less frequently. For example, using a session salt value, it would not be necessary to rekey the master data key every time the server node 200 (of FIG. 2) is restarted.

Next, the third XOR gate 150A provides the initial state value IS by XORing the precomputed seed value(s) with the key derivation context value KDC. Then, the Keccak permutation block 142 generates the Keccak output value KO by performing exactly one Keccak permutation on the initial state value IS. The truncation block 143 provides the derived key (DK) by performing truncation on the Keccak output value KO. In this way, in some embodiments, the key derivation function block 140 dynamically derives a unique key for each memory block using a KMAC-based derivation function, taking only about five clock cycles to derive each unique key.

After a data key is derived by the key derivation block 140, the derived key (DK) is stored in the key cache 571 for subsequent retrieval. On a cache hit, the multiplexer 572 provides the retrieved key (RK) as the data key to the first encryption engine 130A. On a cache miss, the multiplexer 572 provides the derived key (DK) as the data key to the first encryption engine 130A.

The second encryption engine 130B provides a tweak value (TW) by using a tweak key to encrypt the destination memory address. In some embodiments, the encryption engines 130 each use the AES-256 encryption algorithm. In other embodiments, one or more of the encryption engines 130 uses a suitable encryption algorithm other than the AES-256 encryption algorithm. The first XOR block 150B generates a data encryption input (EI) by XORing the tweak value (TW) with the input data. The first encryption engine 130A provides a data encryption output (EO) by encrypting the data encryption input (EI) with the data key. The second XOR gate 150C provides the encrypted data by XORing the data encryption output (EO) with the tweak value (TW).

The key cache 571 may also be used for the decryption of data. When data read from the off-chip memory is being decrypted, the data decryption block 222 looks up the data key in the key cache 571. On a cache hit, the key is retrieved from the key cache 571. On a cache miss, the data key is derived again.

FIG. 5 shows various optional functions that are performed in some embodiments of the data encryption module 121 and not performed in other embodiments of the data encryption module 121. These optional functions include, for example, the use of a session salt value, the use of a key cache, and the use of a tweak cipher. The use of a key cache provides increased efficiency and reduced power consumption but is not necessary for the operation of the data encryption. The use of a session salt value provides improved resistance to side channel attacks but is not necessary for the operation of the data encryption. The data encryption module 121 may also use other suitable optional features not illustrated in FIG. 5. The data decryption module 222 performs decryption in accordance with any optional features that are used by the data encryption module 121.

The tweak cipher provides increased security at the cost of increased power consumption. In some examples, whether the data encryption module 121 includes tweak encryption may depend upon the size of the memory blocks. In some embodiments in which the size of each memory block is 16 bytes, the use of the tweak cipher may be unnecessary. However, with large memory blocks, such as at least 16 kilobytes each, the tweak cipher may be used to provide increased security.

Additionally, the use of a unique key per memory block enables the use of a straightforward block cipher, such as Advanced Encryption Standard-Cipher Block Chaining (AES-CBC), instead of a tweakable block cipher, such as AES-XTS. Encryption with a straightforward block cipher uses a single key. In contrast, encryption with a tweakable block cipher uses two keys (one for data and one for tweak) and involves additional operations, making it more complex. The use of a straightforward block cipher rather than a tweakable block cipher, enabled by using a unique key per memory block, may reduce the complexity and power consumption of the encryption.

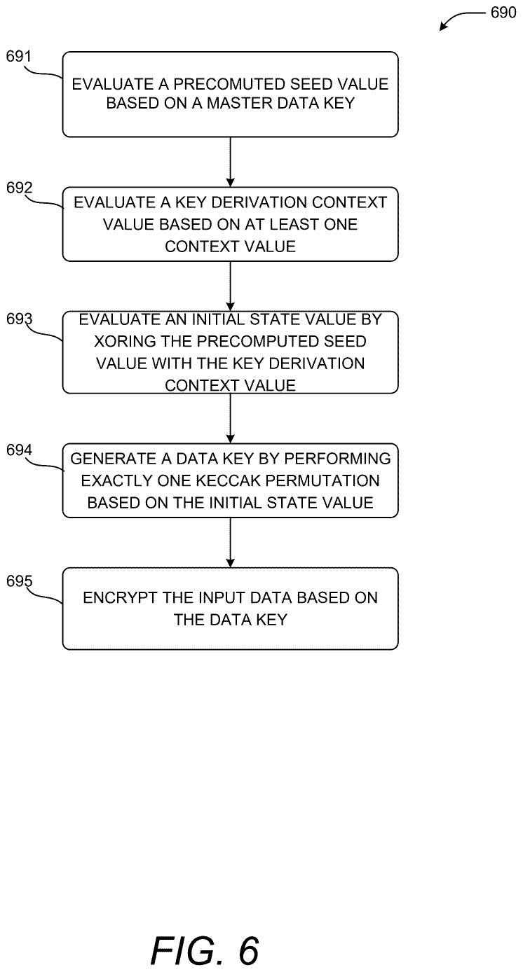

Turning now to FIG. 6, the following section describes aspects of a routine 690 for implementing aspects of the disclosed techniques. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can end at any time and need not be performed in its entirety. Some or all operations of the methods, and/or substantially equivalent operations, can be performed by execution of computer-readable instructions included on a computer-storage media and computer-readable media, as defined herein. The term “computer-readable instructions,” and variants thereof, as used in the description and claims, is used expansively herein to include routines, applications, application modules, program modules, programs, components, data structures, algorithms, or the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, or the like.

Thus, it should be appreciated that, in some embodiments, the logical operations described herein are implemented (1) as a sequence of computer-implemented acts or program modules running on a computing system and/or (2) as interconnected machine logic circuits or circuit modules or other circuit component within the system. Accordingly, the logical operations described herein are referred to variously as states, operations, structural devices, acts, or modules. These operations, structural devices, acts, and modules may be implemented in software, in firmware, in special purpose digital logic, in other circuit components, and any combination thereof.

For example, the operations of the routine are described herein as being implemented, at least in part, by an application, component and/or circuit, such as a device module that can be included in any one of the memory components disclosed herein, including but not limited to RAM. In some configurations, the device module can be a dynamically linked library (DLL), a statically linked library, functionality enabled by an application programing interface (API), a compiled program, an interpreted program, a script or any other executable set of instructions. Data, such as input data or a signal from a sensor, received by the device module can be stored in a data structure in one or more memory components. The data can be retrieved from the data structure by addressing links or references to the data structure.

Although the following illustration refers to the components depicted in the present application, it can be appreciated that the operations of the routine may be also implemented in many other ways. For example, the routine may be implemented, at least in part, by a processor or circuit of another remote computer (which can be a server) or a local processor or circuit of a local computer (which can be a client device receiving a message or a client device sending the message). Any aspect of the routine, which can include the generation of a prompt, communication of any of the messages with the prompt to an Natural Language Processing (NLP) algorithm, use of an NLP algorithm, or a display of a result generated by an NLP algorithm, can be performed on either a device sending a message, a device receiving a message, or on a server managing communication of the messages for a thread. In addition, one or more of the operations of the routine may alternatively or additionally be implemented, at least in part, by a chipset working alone or in conjunction with other software modules. Any service, circuit or application suitable for providing input data indicating the state of any device may be used in operations described herein.

In some embodiments, the routine 690 is performed by a data encryption module, such as data encryption module 121 of one of the previous figures.

The routine 690 starts at operation 691. At operation 691, a precomputed seed value (s) is evaluated based on a master data key. The routine then proceeds to operation 692. At operation 692, a key derivation context value (KDC) is evaluated based on at least one context value. The routine then proceeds to operation 693. At operation 693, an initial state value (IS) is evaluated by XORing the precomputed seed value(s) with the key derivation context value (KDC).

The routine then proceeds to operation 694. At operation 694, a data key is generated based on performing exactly one Keccak permutation based on the initial state value (IS). The data key is unique to the target memory block. Performing the exactly one Keccak permutation on the initial state value (IS) enables generation of the data key with exactly one Keccak permutation invocation. The routine then proceeds to operation 695. At operation 695, based, at least in part, on the data key, the input data is encrypted.

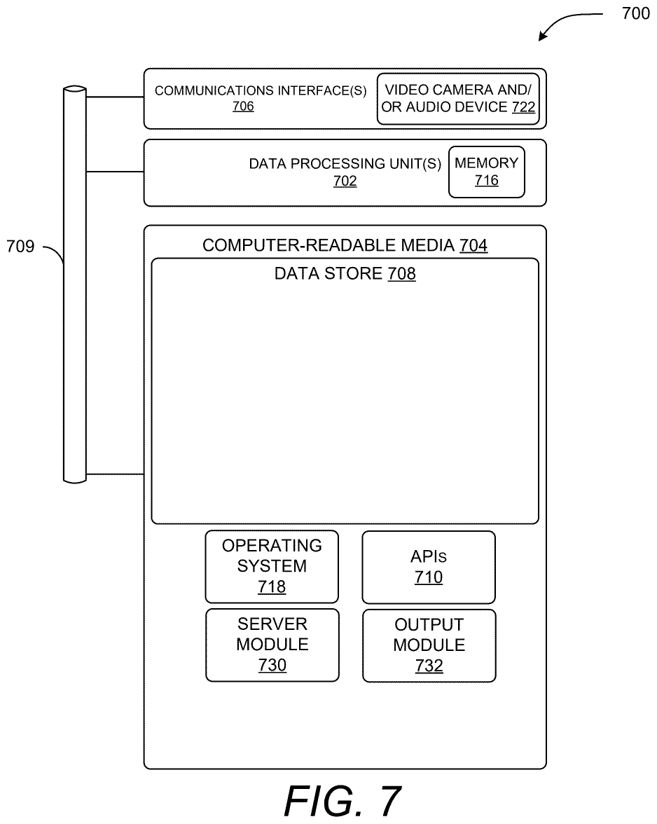

FIG. 7 is a computer architecture diagram illustrating a computing device architecture for a computing device capable of implementing aspects of the techniques and technologies presented herein. FIG. 7 illustrates a diagram that shows example components of a device 700. As illustrated, the device 700 includes one or more data processing unit(s) 702, computer-readable media 704, and communication interface(s) 706. The components of the device 700 are operatively connected, for example, via a bus 709, which may include one or more of a system bus, a data bus, an address bus, a PCI bus, a Mini-PCI bus, and any variety of local, peripheral, and/or independent buses. Some of the one or more processing units 702 may be embodiments of the one or more of the cores 211 of FIG. 2 or may be included in embodiments of the memory controller 201 of FIG. 2.

As utilized herein, data processing unit(s), such as the data processing unit(s) 702, may represent, for example, a CPU-type data processing unit, a GPU-type data processing unit, a field-programmable gate array (“FPGA”), another class of DSP, or other hardware logic components that may, in some instances, be driven by a CPU. For example, and without limitation, illustrative types of hardware logic components that may be utilized include Application-Specific Integrated Circuits (“ASICs”), Application-Specific Standard Products (“ASSPs”), System-on-Chip Systems (“SOCs”), Complex Programmable Logic Devices (“CPLDs”), etc.

As utilized herein, computer-readable media, such as computer-readable media 704, may store instructions executable by the data processing unit(s). The computer-readable media may also store instructions executable by external data processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media, which might also be referred to herein as a computer-readable medium, may include computer storage media and/or communication media. Computer storage media may include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device. The computer storage media can also be referred to herein as computer-readable storage media, non-transitory computer-readable storage media, non-transitory computer-readable medium, computer-readable storage medium, computer-readable storage device, or computer storage medium.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

Communication interface(s) 706 may represent, for example, network interface controllers (“NICs”) or other types of transceiver devices to send and receive communications over a network. Furthermore, the communication interface(s) 706 may include one or more video cameras and/or audio devices 722 to enable generation of video feeds and/or still images, and so forth.

In the illustrated example, computer-readable media 704 includes a data store 708. In some examples, the data store 708 includes data storage such as a database, data warehouse, or other type of structured or unstructured data storage. In some examples, the data store 708 includes a corpus and/or a relational database with one or more tables, indices, stored procedures, and so forth to enable data access including one or more of hypertext markup language (“HTML”) tables, resource description framework (“RDF”) tables, web ontology language (“OWL”) tables, and/or extensible markup language (“XML”) tables, for example. The data store 708 may store data for the operations of processes, applications, components, and/or modules stored in computer-readable media 704 and/or executed by data processing unit(s) 702 and/or accelerator(s).

Alternately, some or all of the above-referenced data can be stored on separate memories 716 on board one or more data processing unit(s) 702 such as a memory on board a CPU-type processor, a GPU-type processor, an FPGA-type accelerator, a DSP-type accelerator, and/or another accelerator. In this example, the computer-readable media 704 also includes an operating system 718 and application programming interface(s) 710 (APIs) configured to expose the functionality and the data of the device 700 to other devices. Additionally, the computer-readable media 704 includes one or more modules such as a server module (730) and an output module (732), although the number of illustrated modules is just an example, and the number may vary. That is, functionality described herein in association with the illustrated modules may be performed by a fewer number of modules or a larger number of modules on one device or spread across multiple devices.

The present disclosure is supplemented by the following clauses:

Clause A: A method for encrypting input data, the method comprising: evaluating a precomputed seed value(s) based on a master data key; and initiating a write access to a target memory block of a plurality of memory blocks in a memory (220), comprising: evaluating a key derivation context value (KDC) based on at least one context value; seed value(s) with the key derivation context value (KDC); generating a data key based on performing exactly one Keccak permutation based on the initial state value (IS), wherein the data key is unique to the target memory block, and wherein performing the exactly one Keccak permutation on the initial state value (IS) enables generation of the data key with exactly one Keccak permutation invocation; and based, at least in part, on the data key, encrypting the input data.

Clause B: The method of Clause A, wherein evaluating the key derivation context value (KDC) based on the at least one context value includes: evaluating a key tag value (KT) from the at least one context value; and evaluating the key derivation context (KDC) by concatenating a session salt value with the key tag value (KT), wherein the session salt value is a secret random value that changes in response to a predetermined event.

Clause C: The method of Clauses A-B, wherein the at least one context value is based on at least one of a memory address, a virtual machine identifier, or a session number that is associated with the input data.

Clause D: The method of Clauses A-C, further comprising: after generating the data key, storing a copy of the data key in a key cache (571) for subsequent retrieval.

Clause E: The method of Clauses A-D, wherein initiating the write access to the target memory block further comprises evaluating a tweak value (TW) by encrypting a target memory address of the input data with a tweak key, and wherein encrypting the input data comprises: evaluating a data encryption input (EI) by XORing the tweak value (TW) with the input data; providing a data encryption output (EO) by encrypting the data encryption input (EI) with the data key; and providing the encrypted data by XORing the data encryption output (EO) with the tweak value (TW).

Clause F: The method of Clauses A-E, wherein evaluating the precomputed seed value(s) based on the master data key comprises: determining whether padding is needed for the master data key; upon determining that padding is needed for the master data key, padding the master data key; and evaluating the precomputed seed value(s) as the first n bits of the master data key, wherein n is a predetermined integer.

Clause G: The method of Clauses A-F, wherein the at least one context value is based on at least a portion of a destination memory address of the input data.

Clause H: The method of Clauses A-G, wherein generating the data key comprises: generating a Keccak permutation output value (KO) by performing exactly one Keccak permutation based on the initial state value (IS); determining whether truncation is needed for the data key; and upon determining that truncation is needed for the data key, generating the data key by truncating the Keccak permutation output value (KO).

Clause I: The method of Clause H, wherein: encrypting the input data comprises using an encryption algorithm to encrypt the input data; determining whether truncation is needed for the data key comprises determining whether the Keccak permutation output value (KO) is of suitable length for the encryption algorithm; and truncating the Keccak permutation output value (KO) comprises truncating the Keccak permutation output value (KO) to have a length that is equal to the suitable length for the encryption algorithm.

Clause J: The method of Clause I, wherein the encryption algorithm is an Advanced Encryption Standard (AES)-256 encryption, and wherein the suitable length is 256 bits.

Clause K. A method for decrypting encrypted data, the method comprising: evaluating a precomputed seed value(s) based on a master data key; receiving the encrypted data and a target memory address that is associated with the encrypted data, wherein the target memory address is associated with a target memory block; and decrypting the encrypted data, comprising: evaluating a key derivation context value (KDC) based on at least one context value that is associated with the target memory address; evaluating an initial state value (IS) by XORing the precomputed seed value(s) with the key derivation context value (KDC); generating a data key based on performing exactly one Keccak permutation based on the initial state value (IS), wherein the data key is unique to the target memory block, and wherein performing the exactly one Keccak permutation on the initial state value (IS) enables generation of the data key with exactly one Keccak permutation invocation; and based, at least in part, on the data key, decrypting the encrypted data.

Clause L: The method of Clause K, wherein evaluating the key derivation context value (KDC) based on the at least one context value includes: evaluating a key tag value (KT) from the at least one context value; and evaluating the key derivation context (KDC) by concatenating a session salt value with the key tag value (KT), wherein the session salt value is a secret random value that changes in response to a predetermined event.

Clause M: The method of Clauses K-L, wherein the at least one context value is based on at least one of a memory address, a virtual machine identifier, or a session number that is associated with the input data.

Clause N: The method of Clauses K-M, wherein generating the data key comprises: generating a Keccak permutation output value (KO) by performing exactly one Keccak permutation based on the initial state value (IS); determining whether truncation is needed for the data key; and upon determining that truncation is needed for the data key, generating the data key by truncating the Keccak permutation output value (KO).

Clause O: The method of Clauses K-N, wherein: decrypting the encrypted data comprises using a decryption algorithm to encrypt the input data; determining whether truncation is needed for the data key comprises determining whether the Keccak permutation output value (KO) is of suitable length for the decryption algorithm; and truncating the Keccak permutation output value (KO) comprises truncating the Keccak permutation output value (KO) to have a length that is equal to the suitable length for the decryption algorithm.

Clause P: A memory controller (201) for encrypting input data, the memory controller comprising: one or more processing units (702); and a computer-readable storage medium (704) having encoded thereon computer-executable instructions to cause the one or more processing units (702) to perform actions, comprising: evaluating a precomputed seed value (s) based on a master data key; and initiating a write access to a target memory block of a plurality of memory blocks in a memory (220), comprising: evaluating a key derivation context value (KDC) based on at least one context value; evaluating an initial state value (IS) by XORing the precomputed seed value(s) with the key derivation context value (KDC); generating a data key based on performing exactly one Keccak permutation based on the initial state value (IS), wherein the data key is unique to the target memory block, and wherein performing the exactly one Keccak permutation on the initial state value (IS) enables generation of the data key with exactly one Keccak permutation invocation; and based, at least in part, on the data key, encrypting the input data.

Clause Q: The memory controller (201) of Clause P, wherein evaluating the key derivation context value (KDC) based on the at least one context value includes: evaluating a key tag value (KT) from the at least one context value; and evaluating the key derivation context (KDC) by concatenating a session salt value with the key tag value (KT), wherein the session salt value is a secret random value that changes in response to a predetermined event.

Clause R: The memory controller (201) of Clauses P-Q, wherein the at least one context value is based on at least one of a memory address, a virtual machine identifier, or a session number that is associated with the input data.

Clause S: The memory controller (201) of Clauses P-R, further comprising: after generating the data key, storing a copy of the data key in a key cache (571) for subsequent retrieval.

Clause T: The memory controller (201) of Clauses P-S, wherein initiating the write access to the target memory block further comprises evaluating a tweak value (TW) by encrypting a target memory address of the input data with a tweak key, and wherein encrypting the input data comprises: evaluating a data encryption input (EI) by XORing the tweak value (TW) with the input data; providing a data encryption output (EO) by encrypting the data encryption input (EI) with the data key; and providing the encrypted data by XORing the data encryption output (EO) with the tweak value (TW).

The meanings identified below do not necessarily limit the terms, but merely provide illustrative examples for the terms. For example, each of the terms “based on” and “based upon” is not exclusive, and is equivalent to the term “based, at least in part, on,” and includes the option of being based on additional factors, some of which may not be described herein. As another example, the term “via” is not exclusive, and is equivalent to the term “via, at least in part,” and includes the option of being via additional factors, some of which may not be described herein. Use of particular textual numeric designators does not imply the existence of lesser-valued numerical designators. The term “or” is an inclusive “or” operator unless specifically indicated otherwise. For example, the phrase “A or B” means “A, B, or A and B.” As used herein, the terms “component” and “system” are intended to encompass hardware, software, or various combinations of hardware and software. Thus, for example, a system or component may be a process, a process executing on a computing device, the computing device, or a portion thereof. The meaning of “in” includes “in” and “on.”

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A method for encrypting input data, the method comprising:
evaluating a precomputed seed value(s) based on a master data key; and
initiating a write access to a target memory block of a plurality of memory blocks in a memory, comprising:
evaluating a key derivation context value (KDC) based on at least one context value;
evaluating an initial state value (IS) by XORing the precomputed seed value (s) with the key derivation context value (KDC);
generating a data key based on performing exactly one Keccak permutation based on the initial state value (IS), wherein the data key is unique to the target memory block, and wherein performing the exactly one Keccak permutation on the initial state value (IS) enables generation of the data key with exactly one Keccak permutation invocation; and
using, at least in part, the data key to encrypt the input data.

2. The method of claim 1, wherein evaluating the key derivation context value (KDC) based on the at least one context value comprises:
evaluating a key tag value (KT) from the at least one context value; and
evaluating the key derivation context (KDC) by concatenating a session salt value with the key tag value (KT), wherein the session salt value is a secret random value that changes in response to a predetermined event.

3. The method of claim 1, wherein the at least one context value is based on at least one of a memory address, a virtual machine identifier, or a session number that is associated with the input data.

4. The method of claim 1, further comprising:
after generating the data key, storing a copy of the data key in a key cache for subsequent retrieval.

5. The method of claim 1, wherein initiating the write access to the target memory block further comprises evaluating a tweak value (TW) by encrypting a target memory address of the input data with a tweak key, and wherein encrypting the input data comprises:
evaluating a data encryption input (EI) by XORing the tweak value (TW) with the input data;
providing a data encryption output (EO) by encrypting the data encryption input (EI) with the data key; and
providing the encrypted data by XORing the data encryption output (EO) with the tweak value (TW).

6. The method of claim 1, wherein evaluating the precomputed seed value(s) based on the master data key comprises:
determining whether padding is needed for the master data key;
upon determining that padding is needed for the master data key, padding the master data key; and
evaluating the precomputed seed value(s) as the first n bits of the master data key, wherein n is a predetermined integer.

7. The method of claim 1, wherein the at least one context value is based on at least a portion of a destination memory address of the input data.

8. The method of claim 1, wherein generating the data key comprises:
generating a Keccak permutation output value (KO) by performing exactly one Keccak permutation based on the initial state value (IS);
determining whether truncation is needed for the data key; and
upon determining that truncation is needed for the data key, generating the data key by truncating the Keccak permutation output value (KO).

9. The method of claim 8, wherein:
encrypting the input data comprises using an encryption algorithm to encrypt the input data;
determining whether truncation is needed for the data key comprises determining whether the Keccak permutation output value (KO) is of suitable length for the encryption algorithm; and
truncating the Keccak permutation output value (KO) comprises truncating the Keccak permutation output value (KO) to have a length that is equal to the suitable length for the encryption algorithm.

10. The method of claim 9, wherein the encryption algorithm is an Advanced Encryption Standard (AES)-256 encryption, and wherein the suitable length is 256 bits.

11. A method for decrypting encrypted data, the method comprising:
evaluating a precomputed seed value(s) based on a master data key;
receiving the encrypted data and a target memory address that is associated with the encrypted data, wherein the target memory address is associated with a target memory block; and
decrypting the encrypted data, comprising:
evaluating a key derivation context value (KDC) based on at least one context value that is associated with the target memory address;
evaluating an initial state value (IS) by XORing the precomputed seed value (s) with the key derivation context value (KDC);
generating a data key based on performing exactly one Keccak permutation based on the initial state value (IS), wherein the data key is unique to the target memory block, and wherein performing the exactly one Keccak permutation on the initial state value (IS) enables generation of the data key with exactly one Keccak permutation invocation; and
based, at least in part, on the data key, decrypting the encrypted data.

12. The method of claim 11, wherein evaluating the key derivation context value (KDC) based on the at least one context value comprises:
evaluating a key tag value (KT) from the at least one context value; and
evaluating the key derivation context (KDC) by concatenating a session salt value with the key tag value (KT), wherein the session salt value is a secret random value that changes in response to a predetermined event.

13. The method of claim 11, wherein the at least one context value is based on at least one of a memory address, a virtual machine identifier, or a session number that is associated with the input data.

14. The method of claim 11, wherein generating the data key comprises:
generating a Keccak permutation output value (KO) by performing exactly one Keccak permutation based on the initial state value (IS);
determining whether truncation is needed for the data key; and
upon determining that truncation is needed for the data key, generating the data key by truncating the Keccak permutation output value (KO).

15. The method of claim 14, wherein:
decrypting the encrypted data comprises using a decryption algorithm to encrypt the input data;
determining whether truncation is needed for the data key comprises determining whether the Keccak permutation output value (KO) is of suitable length for the decryption algorithm; and
truncating the Keccak permutation output value (KO) comprises truncating the Keccak permutation output value (KO) to have a length that is equal to the suitable length for the decryption algorithm.

16. A memory controller for encrypting input data, the memory controller comprising:
one or more processing units; and
a computer-readable storage medium having encoded thereon computer-executable instructions to cause the one or more processing units to perform actions, comprising:
evaluating a precomputed seed value(s) based on a master data key; and
initiating a write access to a target memory block of a plurality of memory blocks in a memory, comprising:
evaluating a key derivation context value (KDC) based on at least one context value;
evaluating an initial state value (IS) by XORing the precomputed seed value(s) with the key derivation context value (KDC);
generating a data key based on performing exactly one Keccak permutation based on the initial state value (IS), wherein the data key is unique to the target memory block, and wherein performing the exactly one Keccak permutation on the initial state value (IS) enables generation of the data key with exactly one Keccak permutation invocation; and
based, at least in part, on the data key, encrypting the input data.

17. The memory controller of claim 16, wherein evaluating the key derivation context value (KDC) based on the at least one context value comprises:
evaluating a key tag value (KT) from the at least one context value; and
evaluating the key derivation context (KDC) by concatenating a session salt value with the key tag value (KT), wherein the session salt value is a secret random value that changes in response to a predetermined event.

18. The memory controller of claim 16, wherein the at least one context value is based on at least one of a memory address, a virtual machine identifier, or a session number that is associated with the input data.

19. The memory controller of claim 16, further comprising:
after generating the data key, storing a copy of the data key in a key cache for subsequent retrieval.

20. The memory controller of claim 16, wherein initiating the write access to the target memory block further comprises evaluating a tweak value (TW) by encrypting a target memory address of the input data with a tweak key, and wherein encrypting the input data comprises:
evaluating a data encryption input (EI) by XORing the tweak value (TW) with the input data;
providing a data encryption output (EO) by encrypting the data encryption input (EI) with the data key; and
providing the encrypted data by XORing the data encryption output (EO) with the tweak value (TW).
